(19) United States
(12) Patent Application Publication
(10) Pub. No.: US 2005/0243424 A1
(43) Pub. Date: Nov. 3, 2005

(54) Variable visual effect generating apparatus

(76) Inventor: Chiou-Haun Lee, Taichung City (TW)

Correspondence Address: CHARLES E. BAXLEY, ESQ., 90 JOHN STREET, THIRD FLOOR, NEW YORK, NY, 10038, US

(21) Appl. No.: 10/836,721

(22) Filed: Apr. 30, 2004

(51) Int. Cl. G02B 5/18

(52) U.S. Cl. 359/567; 359/233

(57) ABSTRACT

A variable visual effect generating apparatus includes a base sheet member, which has a design formed of spaced elements (lines, dots, or geometric patterns), and a transparent face sheet member, which has a design formed of spaced elements (lines, dots, or geometric patterns) and is overlapped on and rotatable relative to the base sheet member to produce a variable visual effect.

### BACKGROUND OF THE INVENTION

1. Field of the Invention

The present invention relates to visual effect generating apparatus and more particularly, to a variable visual effect generating apparatus.

2. Description of the Related Art

There are known detachable device face panels that have a bottom layer, a first intermediate layer carrying a first pattern, a second intermediate layer carrying a second pattern, and a transparent top layer having raised portions. The first intermediate layer and the second intermediate layer are sandwiched in between the bottom layer and the top layer, keeping the first pattern and the second pattern in a crossed manner. The raised portions of the top layer function as convex lenses to deflect light, thereby producing a visual effect. These detachable device face panels have a complicated structure, resulting in a high manufacturing cost. Further, the angle of incident light affects the display of the image. The image of the overlapped patterns of the intermediate layers can be seen only under a particular angle of incident light.

### SUMMARY OF THE INVENTION

The present invention has been accomplished under the circumstances in view. It is the main object of the present invention to provide a variable visual effect generating apparatus, which produces a variable visual effect upon rotary motion of the face sheet member relative to the base sheet member, having no concern of the angle of incident light. It is another object of the present invention to provide a variable visual effect generating apparatus, which is easy and inexpensive to manufacture. To achieve these and other objects of the present invention, the variable visual effect generating apparatus comprises a base sheet member, which has a design formed of spaced elements, and a transparent face sheet member, which has a design formed of spaced elements and is overlapped on the base sheet member. The spaced elements of the designs of the base sheet member and the face sheet member can be parallel lines, transversely longitudinally aligned dots, geometric patterns, etc. The face sheet member is rotatable relative to the base sheet member. A variable visual effect is produced when rotating the face sheet member relative to the base sheet member.

### BRIEF DESCRIPTION OF THE DRAWINGS

FIG. 1 is a front view of a base sheet member and a face sheet member for a variable visual effect generating apparatus according to the first embodiment of the present invention.

FIG. 2 is a front view of the first embodiment of the present invention, showing the face sheet member overlapped on the base sheet member.

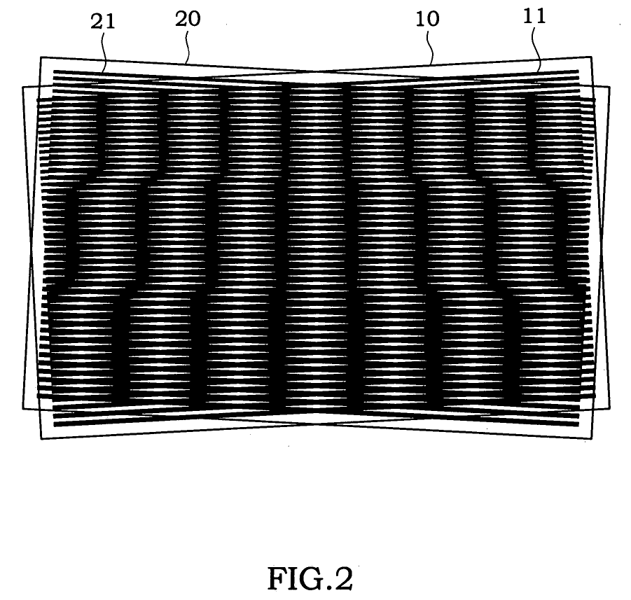

FIG. 3 is similar to FIG. 2 but showing the angular position of the face sheet member adjusted relative to the base sheet member.

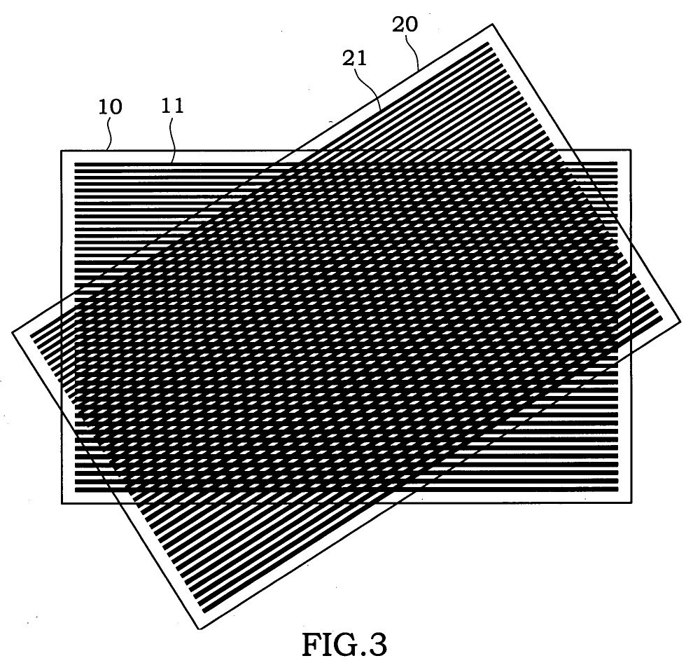

FIG. 4 is similar to FIG. 3 but showing the angular position of the face sheet member adjusted relative to the base sheet member.

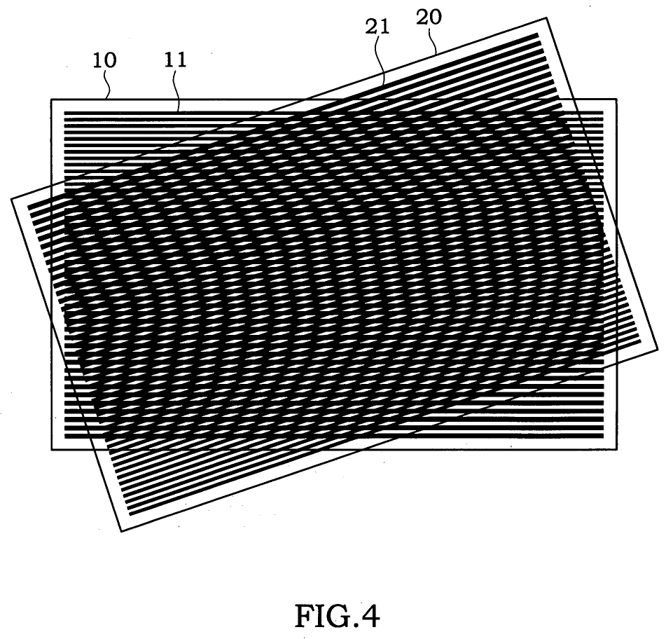

FIG. 5 is similar to FIG. 4 but showing the angular position of the face sheet member adjusted relative to the base sheet member.

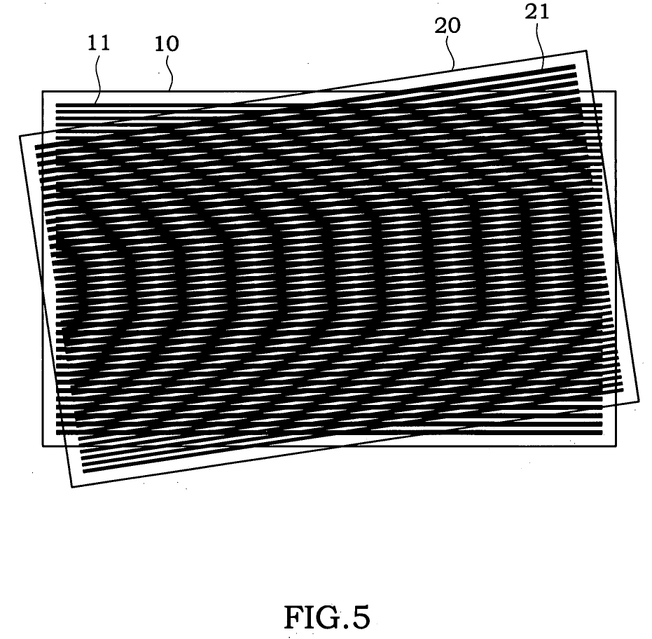

FIG. 6 is similar to FIG. 5, but showing the face sheet member arranged across the base sheet member.

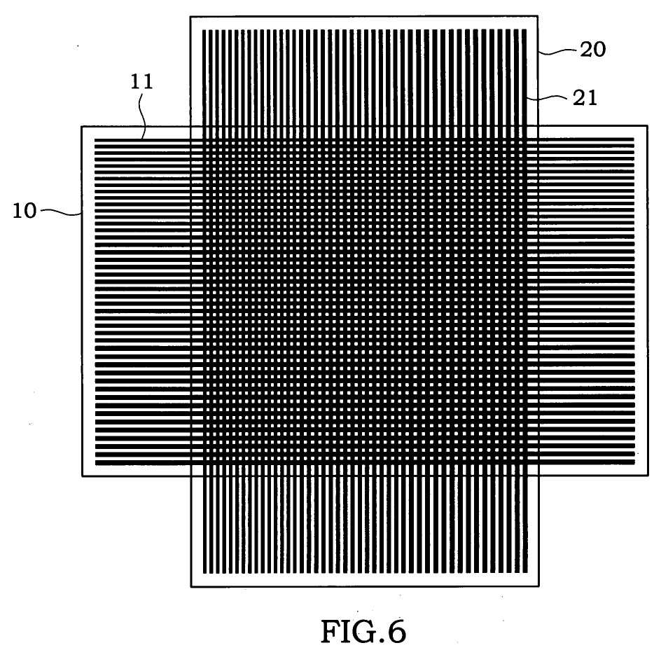

FIG. 7 is a front view of a base sheet member and a face sheet member for a variable visual effect generating apparatus according to the second embodiment of the present invention.

FIG. 8 is a front view of the second embodiment of the present invention, showing the face sheet member overlapped on the base sheet member.

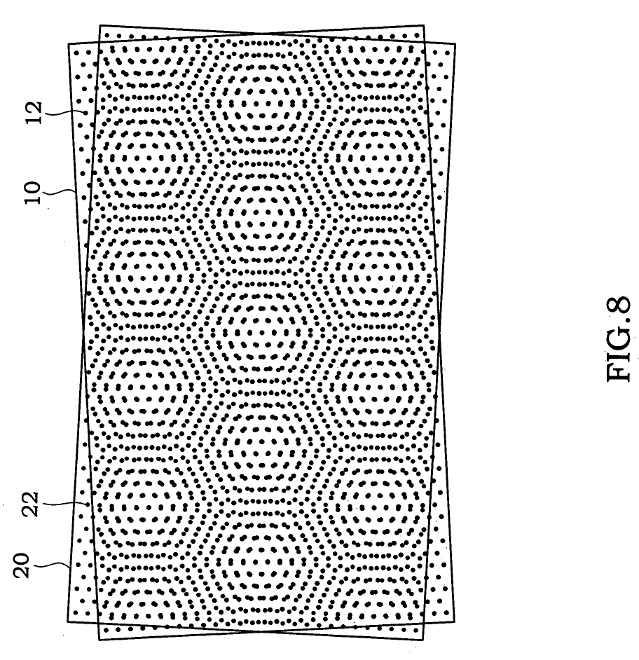

FIG. 9 is similar to FIG. 8 but showing the angular position of the face sheet member adjusted relative to the base sheet member.

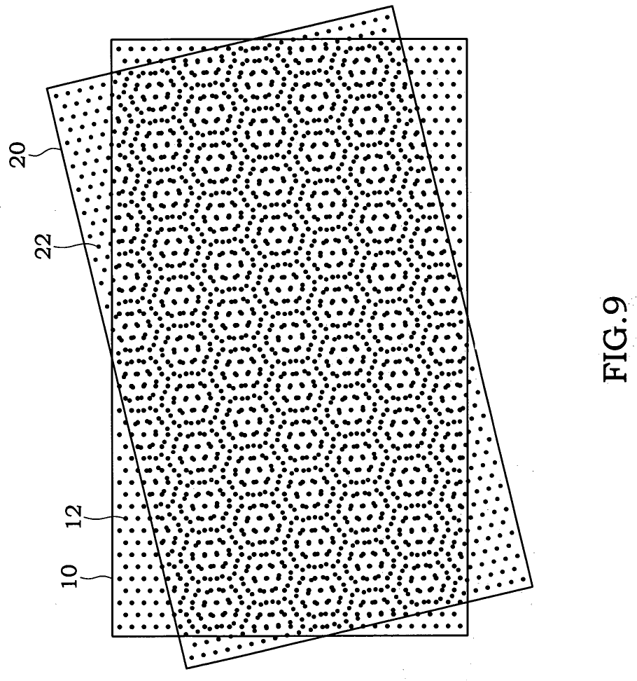

FIG. 10 is similar to FIG. 9 but showing the angular position of the face sheet member adjusted relative to the base sheet member.

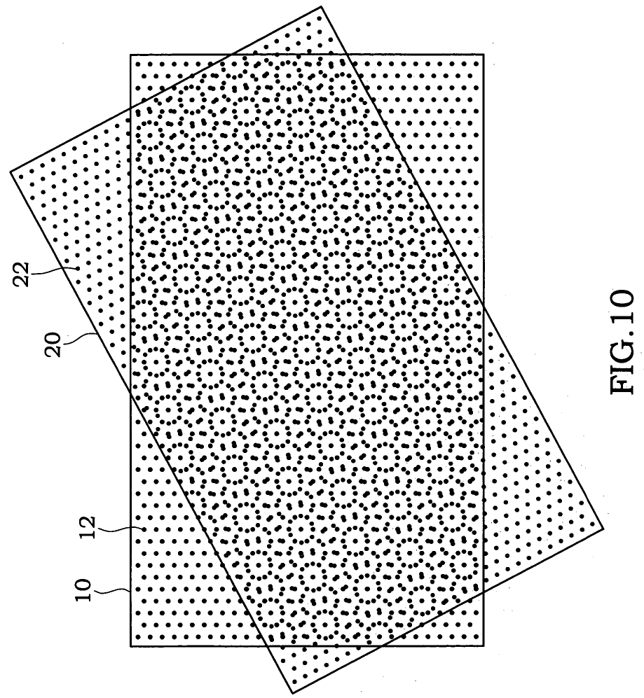

FIG. 11 is a front view of a base sheet member and a face sheet member for a variable visual effect generating apparatus according to the third embodiment of the present invention.

FIG. 12 is a front view of the third embodiment of the present invention, showing the face sheet member overlapped on the base sheet member.

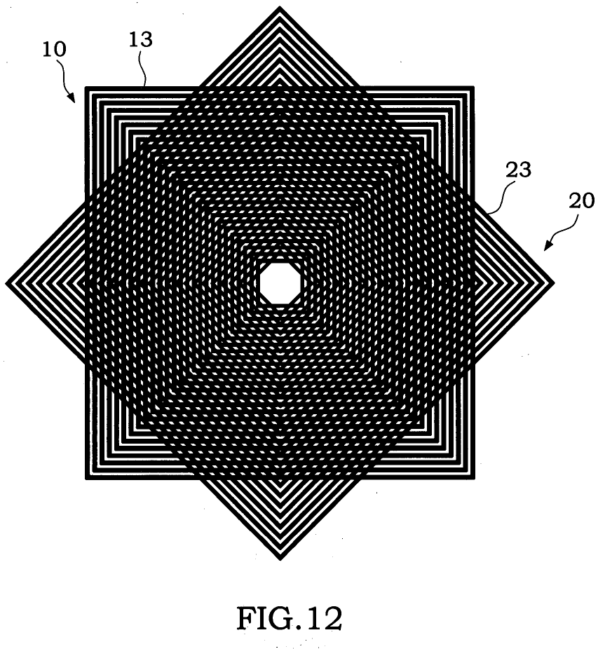

FIG. 13 is similar to FIG. 12 but showing the angular position of the face sheet member adjusted relative to the base sheet member.

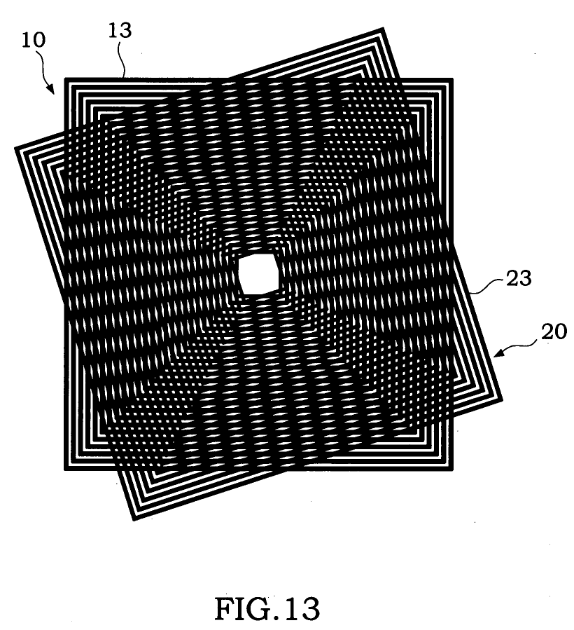

### DETAILED DESCRIPTION OF THE PREFERRED EMBODIMENT

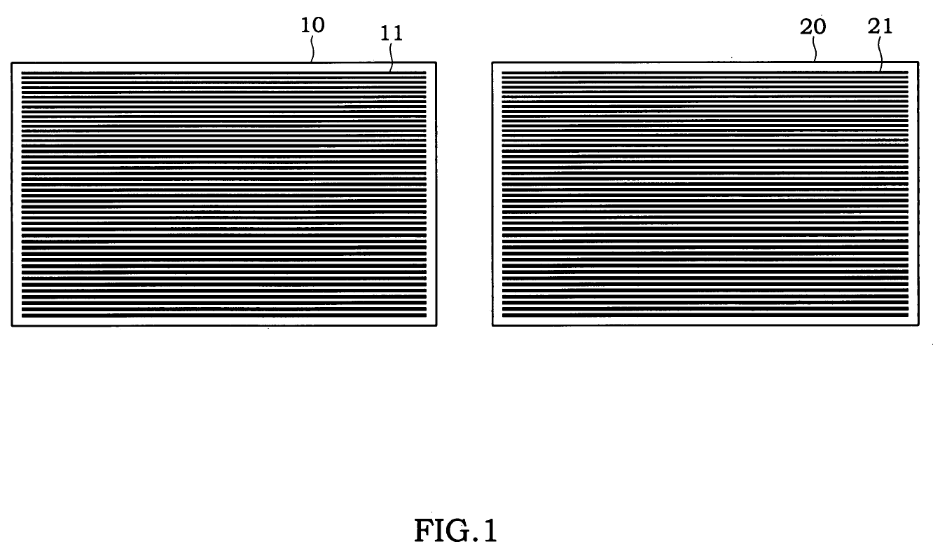

Referring to FIGS. 1˜6, a variable visual effect generating apparatus in accordance with the first embodiment of the present invention is shown comprised of a base sheet member 10, and a face sheet member 20 overlapped on the base sheet member 10 and rotatable relative to the base sheet member 10. The face sheet member 20 admits light. The base sheet member 10 and the face sheet member 20 each have a design formed of equally spaced parallel lines 11, 21. The lines 11, 21 are light tight. The lines 11, 21 may be made having a width gradually increasing from one end to another. Alternatively, the lines 11, 21 can be made having an equal width at both ends. When rotating the face sheet member 20 relative to the base sheet member 10 to a different angle, a different visual image is seen.

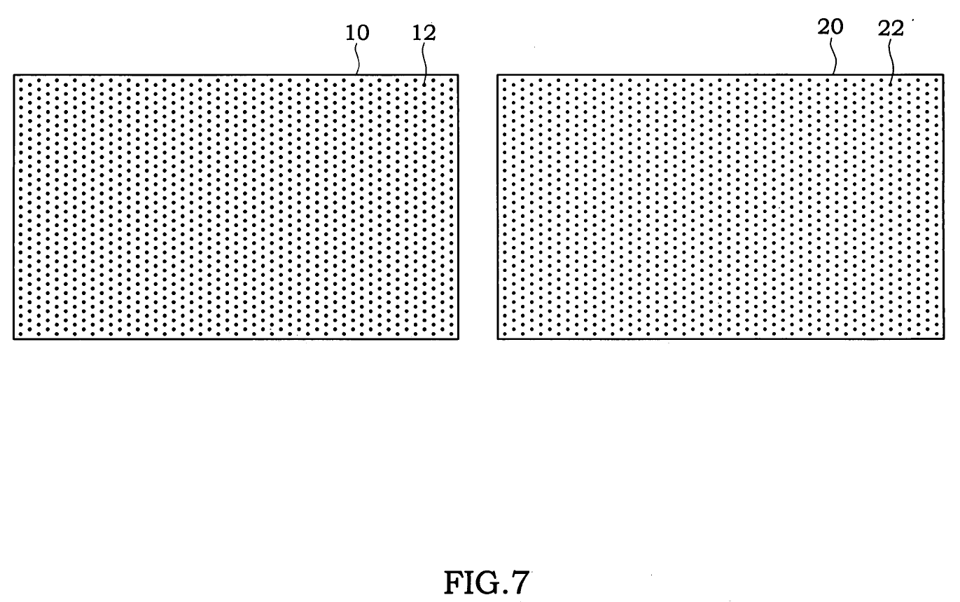

FIGS. 7˜10 show a variable visual effect generating apparatus according to the second embodiment of the present invention. According to this embodiment, the base sheet member 10 and the face sheet member 20 each have a design formed of longitudinally transversely aligned dots 12, 22. The dots 12, 22 are light tight. When rotating the face sheet member 20 relative to the base sheet member 10 to a different angle, a different visual image is seen.

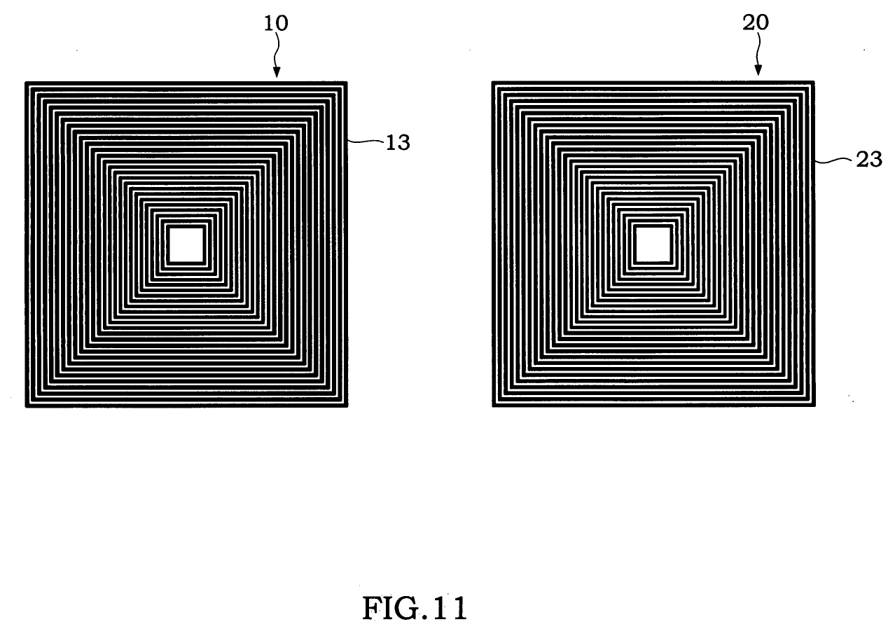

FIGS. 11˜13 show a variable visual effect generating apparatus according to the third embodiment of the present invention. According to this embodiment, the base sheet member 10 and the face sheet member 20 each have a design formed of concentrically arranged geometric patterns 13, 23. The geometric patterns 13, 23 are light tight. When rotating the face sheet member 20 relative to the base sheet member 10 to a different angle, a different visual image is seen.

The variable visual effect generating apparatus can be employed to mobile phone face panels, mobile phone accessories, accessories for personal items (belt buckle, necktie clip, hair clip, shoe vamp, etc.), writing materials, toys, daily consumers' goods, clothes, and etc. Light source may be provided to illuminate the variable visual effect generating apparatus, or to provide a flashing light to the variable visual effect generating apparatus. Rotary driving means may be used to rotate the face sheet member relative to the base sheet member. Further, the base sheet member can be transparent. Alternatively, the base sheet member can be made of light tight material.

Although particular embodiments of the invention have been described in detail for purposes of illustration, various modifications and enhancements may be made without departing from the spirit and scope of the invention. Accordingly, the invention is not to be limited except as by the appended claims.

1. A variable visual effect generating apparatus comprising:
a base sheet member, said base sheet having a design formed of spaced elements; and
a face sheet member overlapped on and rotatable relative to said base sheet member, said face sheet member admitting light and having a design formed of spaced elements.

2. The variable visual effect generating apparatus as claimed in claim 1, wherein said base sheet member admits light.

3. The variable visual effect generating apparatus as claimed in claim 1, wherein said base sheet member is light tight.

4. The variable visual effect generating apparatus as claimed in claim 1, wherein the elements of the design of said base sheet member admits light.

5. The variable visual effect generating apparatus as claimed in claim 1, wherein the elements of the design of said base sheet member are light tight.

6. The variable visual effect generating apparatus as claimed in claim 1, wherein the spaced elements of the design of said base sheet member are spaced lines.

7. The variable visual effect generating apparatus as claimed in claim 6, wherein said lines each have a width gradually increasing from a first end thereof toward a second end thereof.

8. The variable visual effect generating apparatus as claimed in claim 1, wherein the spaced elements of the design of said base sheet member are dots.

9. The variable visual effect generating apparatus as claimed in claim 1, wherein the spaced elements of the design of said base sheet member are geometric patterns.

10. The variable visual effect generating apparatus as claimed in claim 1, wherein the spaced elements of the design of said base sheet have different shapes.

11. The variable visual effect generating apparatus as claimed in claim 1, wherein the elements of the design of said face sheet member admits light.

12. The variable visual effect generating apparatus as claimed in claim 1, wherein the elements of the design of said face sheet member are light tight.

13. The variable visual effect generating apparatus as claimed in claim 1, wherein n the spaced elements of the design of said face sheet member are spaced lines.

14. The variable visual effect generating apparatus as claimed in claim 13, wherein the spaced lines of the design of said face sheet member each have a width gradually increasing from a first end thereof toward a second end thereof.

15. The variable visual effect generating apparatus as claimed in claim 1, wherein the spaced elements of the design of said face sheet member are dots.

16. The variable visual effect generating apparatus as claimed in claim 1, wherein the spaced elements of the design of said face sheet member are geometric patterns.

17. The variable visual effect generating apparatus as claimed in claim 1, wherein the spaced elements of the design of said face sheet have different shapes.

18. The variable visual effect generating apparatus as claimed in claim 1, further comprising light source means adapted to emit light onto said face sheet member.
